(19) United States
(12) Patent Application Publication
(10) Pub. No.: US 2026/0260566 A1
(43) Pub. Date: Sep. 3, 2026

(54) Driver Assistance Method for Vehicles and System for the Performance of Cooperative Driving Maneuvers by a Plurality of Vehicles

(71) Applicant: Bayerische Motoren Werke Aktiengesellschaft, Muenchen (DE)

(72) Inventors: Uwe MOSER, Muenchen (DE); Felix REMPE, Dachau (DE)

(21) Appl. No.: 19/162,992

(22) PCT Filed: Jan. 30, 2024
(86) PCT No.: PCT/EP2024/052207

§ 371 Date: Sep. 8, 2025

(30) Foreign Application Priority Data
Mar. 16, 2023 (DE) 10 2023 106 657.9

(51) Int. Cl. G08G 1/0967; B60W 30/18; B60W 60/00; G08G 1/16

(52) U.S. Cl. CPC G08G 1/096791; B60W 30/18163; B60W 60/001; G08G 1/096725; G08G 1/166; B60W 2552/10; B60W 2554/802; B60W 2556/45; B60W 2556/65; B60W 2754/30

(57) ABSTRACT

The disclosure relates to a driving assistance method, including performance of cooperative driving maneuvers by a plurality of vehicles for a first vehicle to perform a first lane change from a first to a second lane and a subsequent second lane change from the second to a third lane, the second lane located between the first and third lanes. The cooperative driving maneuvers including: performance of driving maneuvers by two vehicles of the plurality of vehicles located one behind the other in the second lane, to create a gap in the second lane, wherein a second vehicle of the two vehicles performs a lane change and a third vehicle of the two vehicles creates the gap in the second lane; and sequential performance, by the first vehicle, of the first lane change into the gap and of the second lane change into the third lane.

### BACKGROUND AND SUMMARY

The present disclosure relates to a driver assistance method for vehicles and a system for performing cooperative driving maneuvers by a plurality of vehicles. The present disclosure relates in particular to enabling lane changes for a vehicle in heavy traffic.

Driver assistance systems for automated driving are steadily gaining in importance. Automated driving can be carried out with different degrees of automation. Exemplary degrees of automation are assisted, semi-automated, conditionally automated, highly automated, or fully automated driving. The above-mentioned five automation levels correspond to SAE levels 1 to 5 of the standard SAE J3016 (SAE—Society of Automotive Engineering) as of 30 Apr. 2021. In fully automated driving (SAE Level 5), all aspects of the dynamic driving task that could also be controlled by a human driver can be performed by the system under any road and environmental conditions.

An example of a driver assistance system is lane change assistant, which can perform an automatic lane change or assist a driver in changing lanes manually. To do this, the lane change assistant uses data from an environment sensor system that perceives the environment on a visual basis, both in the area visible to humans and the area that is not visible to humans. The environment sensor system can, for example, contain a camera, radar, and/or LiDAR.

An ego vehicle may want or even have to change lanes for a variety of reasons, for example because a current route provides for an exit from the freeway or the current lane is closed downstream and therefore carrying on in the current lane would pose a danger to the ego vehicle. However, in heavy traffic, it can be difficult to make such lane changes. In particular, the ego vehicle is often dependent on the third-party vehicles in the adjacent lane creating sufficient space so that the ego vehicle can cut in without braking and thus in an energy-efficient manner.

For such lane changes in heavy traffic, risky and/or extensive driving maneuvers of the ego vehicle and/or the third-party vehicles in the adjacent lane, such as for example braking maneuvers, can be necessary to enable the ego vehicle to cut in into the adjacent lane. This can lead to an impairment of road safety. In addition, such driving maneuvers can lead to increased energy consumption, especially in the ego vehicle as well as in the case of third-party vehicles in the adjacent lane, for example by disrupting an automated convoy with minimized vehicle separation.

It is an object of the present disclosure to specify a driver assistance method for vehicles and a system for performing cooperative driving maneuvers by a plurality of vehicles that allow the lane change of a vehicle in heavy traffic. In addition, it is an object of the present disclosure to improve safety in road traffic and/or to increase energy efficiency when changing lanes.

This object is addressed by the subject matter of the independent claim. Advantageous embodiments and implementations are given in the dependent claims.

According to one aspect of the present disclosure a driver assistance method for vehicles is specified. Some forms of a driving assistance method includes a performance of cooperative driving maneuvers by a plurality of vehicles in order to enable a first vehicle of the plurality of vehicles to perform a first lane change lanes from a first lane to a second lane and then a second lane change from the second lane to a third lane, wherein the second lane is located between the first lane and the third lane.

Performing cooperative driving maneuvers by the plurality of vehicles involves performing driving maneuvers by two vehicles of the plurality of vehicles that are located one behind the other in the second lane to create a gap in the second lane, wherein a second vehicle of the two vehicles performs the lane change and a third vehicle of the two vehicles performs a deceleration or acceleration process in order to create the gap in the second lane; and a sequential execution by the first vehicle of the first lane change into the gap in the second lane and the second lane change to the third lane.

According to forms of the invention, cooperative driving maneuvers are carried out by vehicles in order to enable an ego vehicle to perform a sequence of lane changes. For example, the ego vehicle can transmit its lane change requests to the vehicles in the densely populated adjacent lane. The vehicles in the densely populated adjacent lane calculate optimal driving maneuvers that allow the ego vehicle to cut in and affect as few vehicles as possible in the convoy, so that the driving maneuvers can be performed as energy-efficiently as possible. In particular, only two vehicles may be involved in the cooperative driving maneuvers in the adjacent lane of the ego vehicle, so that disruption of a convoy on the adjacent lane can be limited. Subsequently, the calculated driving maneuvers are performed synchronously and in a coordinated way by the participating vehicles.

As a result, the ego vehicle can perform rapid lane changes without braking, so that the risk of a rear-end collision can be reduced and traffic flow can be more fluid. In addition, the number of vehicles participating in the cooperative driving maneuvers is minimized, so that a disruption to a convoy on the adjacent lane can be limited and energy can be saved.

In some implementations, the second vehicle performs the lane change from the second lane into the first lane. For example, the second vehicle can change to the first lane in front of the first vehicle. However, the present disclosure is not limited to this, and the second vehicle may alternatively change to the first lane behind the first vehicle.

In some implementations, the third vehicle performs the deceleration or acceleration process in order to create the gap in the second lane level with the first vehicle that is still located in the first lane. “Level of the first vehicle” means that the gap is created (directly) next to the first vehicle, i.e. perpendicular to a direction of travel of the first vehicle and/or the second vehicle. For example, the third vehicle may perform the deceleration or acceleration process in such a way that the third vehicle occupies a place of the second vehicle in the second lane that has been vacated due to its previous lane change. In some embodiments, the third vehicle may be level with the second vehicle or next to the second vehicle after the deceleration or acceleration process.

The first vehicle can then perform the first lane change into the gap in the second lane and the second lane change to the third lane.

In some implementations, the second vehicle performs a lane change from the first lane back to the second lane after the first vehicle has performed the second lane change to the third lane. In particular, the second vehicle can perform the lane change from the first lane back to the second lane in front of or behind the third vehicle.

For example, before the second vehicle performs the lane change back to the second lane, the third vehicle may perform a deceleration process in order to vacate the original place of the second vehicle in the second lane again and return to its own place in the convoy in the second lane. The second vehicle can then return to its former place in the convoy by the lane change back to the second lane.

Alternatively, the second vehicle can perform a deceleration process before the lane change in order to cut back into the second lane behind the third vehicle. Compared to the initial situation, the second vehicle and the third vehicles have thus swapped their places in the convoy.

In some implementations, the third lane is selected from the group that includes or consists of a breakdown lane, a deceleration lane, and an exit (for example a freeway exit).

In some implementations, the performance of the cooperative driving maneuvers by the plurality of vehicles involves the performance of cooperative driving maneuvers by two other vehicles of the plurality of vehicles located one after the other in the third lane in order to create another gap in the third lane, wherein a fourth vehicle of the two other vehicles performs a lane change and a fifth vehicle of the two other vehicles performs a deceleration or acceleration process in order to create the further gap in the third lane, wherein the first vehicle sequentially performs the first lane change into the gap in the second lane, the second lane change into the further gap in the third lane and a third lane change to the fourth lane.

In some implementations, the second vehicle performs the lane change from the second lane to the first lane. For example, the second vehicle can change to the first lane in front of the first vehicle. However, the present disclosure is not limited to this, and the second vehicle can alternatively change to the first lane behind the first vehicle.

In some implementations, the third vehicle performs the deceleration or acceleration process in order to create the gap in the second lane level with the first vehicle that is still in the first lane. “Level with the first vehicle” means that the gap is created (directly) next to the first vehicle, i.e. perpendicular to a direction of travel of the first vehicle and/or the second vehicle. For example, the third vehicle may perform the deceleration or acceleration process in such a way that the third vehicle occupies a place for the second vehicle in the second lane which has become vacant due to its previous lane change. In some embodiments, the third vehicle may be level with the second vehicle or next to the second vehicle after the deceleration or acceleration process.

The first vehicle can then perform the first lane change into the gap in the second lane. For example, the first vehicle may be behind the third vehicle after the first lane change.

In some implementations, the second vehicle performs a deceleration or acceleration process in the first lane so that the second vehicle in the first lane is level with the first vehicle in the second lane. For example, the second vehicle may perform the deceleration or acceleration process in such a way that the second vehicle takes a place of the first vehicle in the first lane that has been vacated as a result of a first lane change to the second lane.

In some implementations, the third vehicle performs a lane change from the second lane to the first lane. For example, the third vehicle can change to the first lane in front of the second vehicle. However, the present disclosure is not limited to this and the third vehicle may alternatively change to the first lane behind the second vehicle.

In some implementations, the fourth vehicle performs a lane change from the third lane to the second lane, for example so that the fourth vehicle is located in the second lane next to the third vehicle in the first lane and/or in front of the first vehicle. For example, the fourth vehicle can perform the lane change in such a way that the fourth vehicle occupies a place of the third vehicle in the second lane that has been vacated by its previous lane change to the first lane.

In some implementations, the fifth vehicle performs the deceleration or acceleration process on the third lane in order to create the further gap in the third lane, especially level with the first vehicle in the second lane. The fifth vehicle can, for example, perform the deceleration or acceleration process in such a way that the fifth vehicle is in the third lane level with the fourth vehicle in the second lane. In some embodiments, the fifth vehicle may perform the deceleration or acceleration process in such a way that the fifth vehicle occupies a place of the fourth vehicle in the third lane that was vacated by its previously performed lane change to the second lane.

The first vehicle can then perform the second lane change into the further gap in the third lane. For example, the first vehicle may be located behind the fifth vehicle after the second lane change. The first vehicle can then make the third lane change from the third lane to the fourth lane.

In some implementations, the second vehicle will perform a lane change from the first lane back to the second lane after the first vehicle has performed the second lane change to the third lane (and optionally also the third lane change to the fourth lane). For example, the second vehicle can perform the lane change in front of or behind the fourth vehicle. In some embodiments, the second vehicle can perform a further lane change from the second lane to the third lane, for example behind the fifth vehicle.

In some implementations, the third vehicle performs a deceleration or acceleration process in the first lane. For example, the third vehicle may perform the deceleration or acceleration process in such a way that the third vehicle occupies a place of the second vehicle in the first lane that was vacated by its previous lane change to the second lane.

In some implementations, the third vehicle performs a lane change from the first lane back to the second lane after the first vehicle has performed the second lane change to the third lane and optionally the third lane change to the fourth lane. For example, the third vehicle can perform the lane change behind the fourth vehicle in the second lane.

In some implementations, the fourth lane is selected from the group that includes or that consists of a breakdown lane, a deceleration lane, and an exit (for example a freeway exit).

In some implementations, the vehicles communicate with each other, especially the second vehicle, the third vehicle, the fourth vehicle and the fifth vehicle, and optionally the first vehicle by means of a communication technology, in order to perform the driving maneuvers described above cooperatively and in a time synchronized manner.

In some implementations, the communication technology includes or is vehicle-to-vehicle, V2V, communication. This allows a vehicle to be connected, for example, directly via WiFi to other vehicles in its vicinity in order to perform the driving maneuvers described above cooperatively and in a time synchronized manner.

In some implementations, the communication technology includes, or is, a vehicle-to-X, V2X, communication. This allows the vehicle to be connected directly for example to a backend and/or a technical infrastructure or other stationary sources in its vicinity in order to perform the driving maneuvers described above cooperatively and in a time synchronized manner.

In some implementations, the communication technology includes, or is, a communication over a mobile network. For example, the mobile network can be an LTE network or a 5G network. This allows the vehicle to communicate via the mobile network with at least one external unit, such as other vehicles, a backend, and/or a technical infrastructure, in order to perform the driving maneuvers described above cooperatively and in a time synchronized manner.

The term vehicle includes cars, trucks, buses, motorhomes, motorcycles, etc., which are used for the transport of people, goods, etc. In particular, the term includes motor vehicles for the transport of passengers.

In some implementations, the first vehicle is a motor vehicle for the transport of passengers.

In addition or alternatively, the second vehicle and/or the third vehicle and/or the fourth vehicle and/or the fifth vehicle are trucks. In particular, the second vehicle, the third vehicle, the fourth vehicle and the fifth vehicle can be convoy vehicles that are driving automatically in a convoy.

In some implementations, the second vehicle, the third vehicle, the fourth vehicle and the fifth vehicle, as well as optionally the first vehicle, are automatically driving vehicles. In other words, the second vehicle, the third vehicle, the fourth vehicle and the fifth vehicle as well as optionally the first vehicle can each be equipped with a driver assistance system for automated driving.

The driver assistance system of the first vehicle can contain or be a lane change assistant. The lane change assistant performs lane change planning for the first vehicle. The term “lane change planning” (also referred to as “lane change strategy”) as used in the context of the present disclosure refers to an analysis of a situation of the vehicle in relation to a vehicle environment in order to determine whether and how a lane change should be carried out. For example, the analysis may show that a lane change to an adjacent lane to the right of the ego lane is advantageous and/or should be carried out. A corresponding lane change request can be communicated to the vehicles in the vicinity of the first vehicle, which then calculate (for example by a lead vehicle) and perform the cooperative driving maneuvers in order to enable the first vehicle to perform the desired lane change or lane changes.

In some implementations, the driver assistance system of the first vehicle can be set up to perform the lane change planning based on environmental data provided by an environment sensor system of the first vehicle, optionally in combination with externally received information. In some implementations, the environment sensor system includes at least one laser scanner (for example at least one LiDAR system) and/or at least one radar system and/or at least one camera and/or at least one ultrasound system. The environment sensor system can provide the environmental data (also referred to as “surroundings data”) that depict an environmental area of the vehicle.

In some implementations, the driver assistance system of the first vehicle is set up to automatically guide the vehicle laterally based on the lane change planning and, optionally, to guide the vehicle longitudinally for the first lane change from the first lane to the second lane and the second lane change from the second lane to the third lane and, optionally, the third lane change from the third lane to the fourth lane. In particular, the driver assistance system can be set up to perform automatic lane changes based on the lane change planning. In other words, the driver assistance system can be set up for automated driving, and in particular can be an active lane change assistant.

In the context of the document, the term “automated driving” is understood to mean driving with automated longitudinal and/or transverse guidance. Automated driving can be, for example, driving on the freeway for a longer period of time or driving for a limited period of time during parking. The term “automated driving” includes automated driving with any degree of automation. Exemplary degrees of automation are assisted, semi-automated, conditionally automated, highly automated, and fully automated driving (with an increasing degree of automation in each case). The above-mentioned five automation levels correspond to SAE levels 1 to 5 of the SAE J3016 (SAE—Society of Automotive Engineering) standard as of Apr. 30, 2021.

With assisted driving (SAE Level 1), the system performs the longitudinal or transverse guidance in certain driving situations. With semi-automated driving (SAE Level 2), the system undertakes the longitudinal and transverse guidance in certain driving situations, wherein the driver must continuously monitor the system, as in assisted driving. With conditionally automated driving (SAE Level 3), the system undertakes the longitudinal and lateral guidance in certain driving situations without the driver having to continuously monitor the system; however, the driver must be able to take over the vehicle guidance within a certain time on request by the system. With highly automated driving (SAE Level 4), the system undertakes the vehicle guidance in certain driving situations, even if the driver does not respond to a request for intervention, so that the driver is eliminated as a fallback level. With fully automated driving (SAE Level 5), all aspects of the dynamic driving task which are also controlled by a human driver can be performed by the system under any road and environmental conditions.

In addition, the term “at least partially automated driving or maneuvering” in the context of the document also means partially automated, conditionally automated, highly automated, fully automated driving. In other words, the term “at least partially automated driving” means a degree of automation from and including SAE level 2.

The driver assistance system or lane change assistant of the first vehicle may, in some embodiments, correspond to a degree of automation at which at least automatic lateral guidance or a lane change is possible upon a user input by the driver. One such level of automation can be SAE Level 2, for example.

In some implementations, the driver assistance system of the first vehicle also contains at least one output device that is set up for issuing driver information. In particular, the driver assistance system may be set up to activate the at least one output device for an output of at least one driver information item in relation to lane change planning. Driver information can be output in particular when the first vehicle is being driven manually. The driver information can provide the driver with information and/or instructions regarding lane changes.

In some implementations, the first vehicle contains at least one output device for issuing the driver information, such as visual and/or audible warnings and/or information. The at least one output device can contain at least one display device and/or at least one loudspeaker. The at least one display device may contain a display, in particular an LCD display, a plasma display or an OLED display. In addition or alternatively, the at least one display device may contain a projection device set up to project information directly in the driver's field of view, in particular onto a windscreen. In some embodiments the at least one display device may be a central information output device of an infotainment system, such as a head unit or a pillar-to-pillar display. In some implementations, the at least one output device is permanently installed in the vehicle.

According to another form of the present disclosure, a method for determining cooperative driving maneuvers is specified. Some forms of a method include determining cooperative driving maneuvers for a plurality of vehicles in order to allow a first vehicle of the plurality of vehicles to perform a lane change from a first lane to a second lane and a subsequent second lane change from the second lane to a third lane, wherein the second lane is located between the first lane and the third lane. Determining cooperative driving maneuvers for the plurality of vehicles includes determining driving maneuvers for two vehicles of the plurality of vehicles that are located one after the other in the second lane in order to create a gap in the second lane, wherein the driving maneuvers for a second vehicle of the two vehicles include a lane change and for a third vehicle of the two vehicles include a deceleration or acceleration process to create the gap in the second lane so that the first vehicle can sequentially perform the first lane change into the gap in the second lane and the second lane change into the third lane.

In some implementations, the method is carried out by one or more processors of the second vehicle or the third vehicle.

In other embodiments, the method may be carried out by one or more processors of the first vehicle, the fourth vehicle, the fifth vehicle or another vehicle (for example one not involved in the driving maneuvers). Alternatively, the method can be carried out by a central unit, such as a server or a backend, which is connected to the first vehicle, the second vehicle and the third vehicle and, optionally, to the fourth vehicle and the fifth vehicle.

According to another form of the present disclosure, a software (SW) program is specified. The SW program can be set up to be executed on one or more processors and as a result to carry out the driver assistance method described in this document or a method for determining cooperative driving maneuvers.

According to another form of the present disclosure, a memory medium is specified. The memory medium may contain a SW program that is set up to run processors and as a result to carry out the driver assistance method described in this document or a method for determining cooperative driving maneuvers.

According to another form of the present disclosure, software with program code is specified. The software is set up to carry out the driver assistance method or the method for determining cooperative driving maneuvers when the software is running on software-controlled devices.

According to another form of the present disclosure, a system for performing cooperative driving maneuvers by a plurality of vehicles is specified. The system contains processors; and memories that are connected to the processors and that contain instructions that can be executed by the processors to carry out the driver assistance method described in this document.

In particular, the system can be a distributed system. In other words, the functionalities of the system can be distributed between the first vehicle, the second vehicle and the third vehicle, and optionally the fourth vehicle and the fifth vehicle. In other words, partial functionalities of the overall system can be implemented in the first vehicle, second vehicle and third vehicle as well as optionally in the fourth vehicle and fifth vehicle.

According to another form of the present disclosure, a system for determining cooperative driving maneuvers is specified. The system contains one or more processors and at least one memory. The at least one memory is connected to the one or more processors and contains instructions that can be executed by the one or more processors to determine cooperative driving maneuvers for the plurality of vehicles in order to enable a first vehicle of the plurality of vehicles to perform a first lane change from a first lane to a second lane and a subsequent second lane change from the second lane to a third lane, wherein the second lane is located between the first lane and the third lane. Determining cooperative driving maneuvers for the plurality of vehicles includes determining driving maneuvers for two vehicles of the plurality of vehicles that are located one after the other in the second lane in order to create a gap in the second lane, wherein the driving maneuvers for a second vehicle of the two vehicles include a lane change and for a third vehicle of the two vehicles include a deceleration or acceleration process to create the gap in the second lane so that the first vehicle can sequentially perform the first lane change into the gap in the second lane and the second lane change to the third lane.

The driving maneuvers determined by the system may, according to some embodiments, be designed as described above and below with reference to the driver assistance method according to the invention.

In some implementations, the system is contained or implemented in the second vehicle or third vehicle.

In other embodiments, the system can be contained or implemented in the first vehicle, fourth vehicle, fifth vehicle or another vehicle (for example one not involved in the driving maneuvers). Alternatively, the system can be contained or implemented in a central unit, such as a server or backend, with a communication connection to the first vehicle, the second vehicle, and the third vehicle, and optionally the fourth vehicle and the fifth vehicle.

A processor or a processor module is a programmable computing unit, i.e. a machine or an electronic circuit, that controls other elements in accordance with delivered instructions and thereby drives an algorithm (process).

According to another form of the present disclosure, a vehicle, in particular a motor vehicle, is specified. The vehicle contains the system for determining cooperative driving maneuvers according to the embodiments of the present disclosure.

Exemplary embodiments and implementations are depicted in the figures and are described in more detail below. In the figures:

### BRIEF DESCRIPTION OF DRAWINGS

FIG. 1(a), FIG. 1(b), FIG. 1(c), FIG. 1(d), FIG. 1(e1), FIG. 1(e2), FIG. 1(f1), and FIG. 1(f2) shows schematically cooperative driving maneuvers according to embodiments of the present disclosure,

FIG. 2(a), FIG. 2(b), FIG. 2(c), FIG. 2(d), FIG. 2(e), FIG. 2(f), FIG. 2(g), FIG. 2(h), FIG. 2(i), and FIG. 2(k) shows schematically cooperative driving maneuvers according to further embodiments of the present disclosure, and

FIG. 3 shows schematically a vehicle with a driver assistance system for automated driving according to embodiments of the present disclosure.

### DETAILED DESCRIPTION OF DRAWINGS

Unless otherwise stated, the same reference signs will be used below for identical elements and elements producing the identical effect.

An ego vehicle may want or even have to change lanes for a variety of reasons, for example because a current route stipulates an exit of the freeway or the current lane is closed downstream and continuing to drive in the current lane would therefore pose a danger to the ego vehicle. However, in heavy traffic, it can be difficult to make such lane changes.

According to forms of the invention, cooperative driving maneuvers are carried out by a plurality of vehicles in order to enable the ego vehicle to perform a sequence of lane changes. For example, the ego vehicle can transmit its lane change request to the vehicles in the densely populated adjacent lane. The vehicles on the densely populated adjacent lane calculate optimal driving maneuvers that allow the ego vehicle to cut in and affect as few vehicles as possible in the convoy, so that the driving maneuvers can be performed as energy-efficiently as possible. In particular, only two vehicles may be involved in the cooperative driving maneuvers on the lane adjacent to the ego vehicle, so that disturbance to convoy movement in the adjacent lane can be limited. Subsequently, the calculated driving maneuvers are performed synchronously and in a coordinated way by the participating vehicles.

As a result, the ego vehicle can quickly perform a lane change without braking, so that the risk of a rear-end collision is reduced and the flow of traffic is smoother. In addition, the number of vehicles participating in the cooperative driving maneuvers is minimized, so that disruption of a convoy on the adjacent lane is limited and energy can be saved.

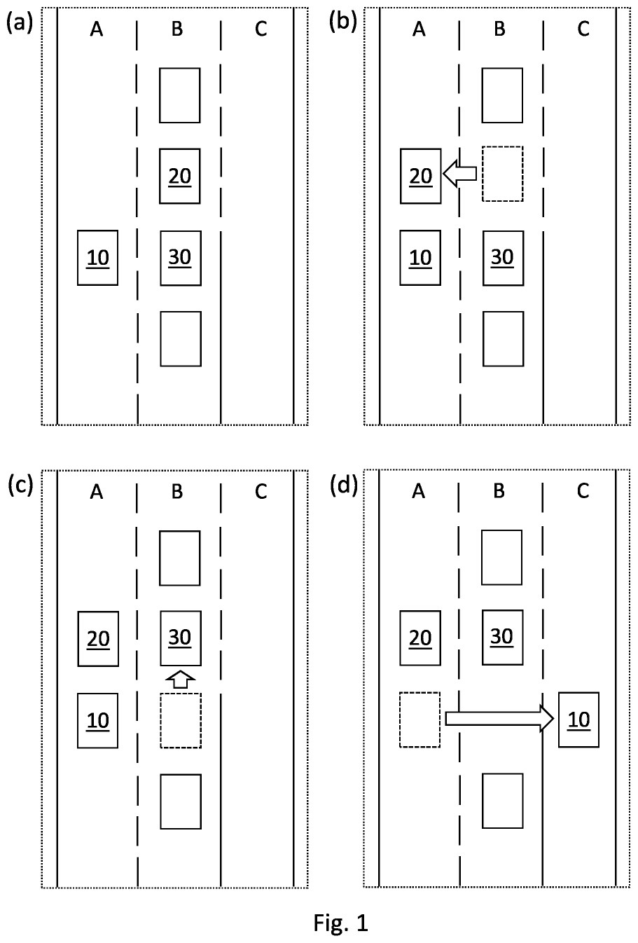

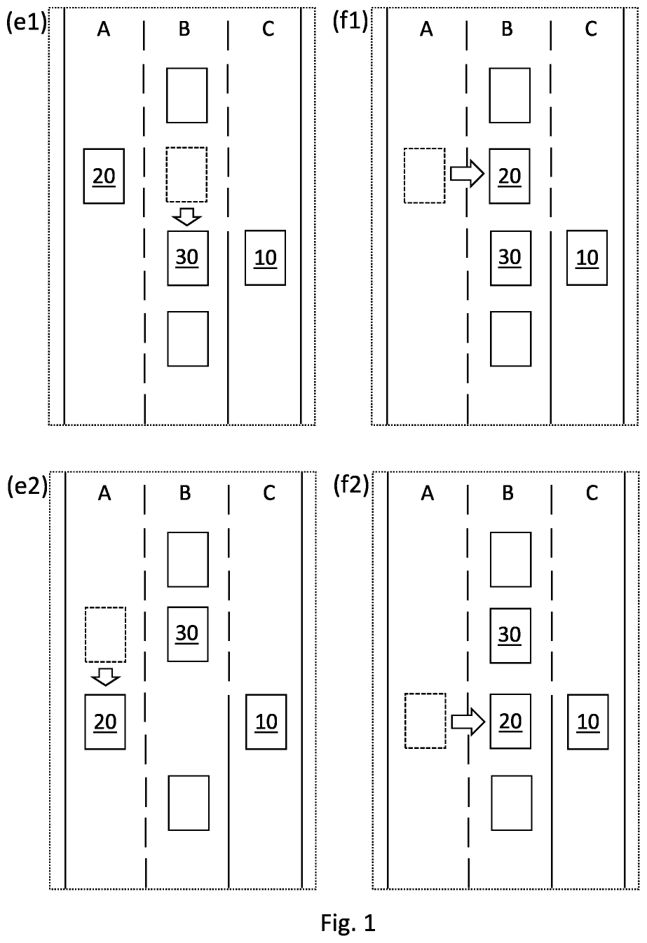

FIG. 1 shows schematically cooperative driving maneuvers according to embodiments of the present disclosure.

A first lane A, a second lane B and a third lane C are depicted schematically, wherein the second lane B is located between the first lane A and the third lane C. The third lane C may be a deceleration lane or an exit (for example a freeway exit) in some embodiments but is not limited to this.

Referring to FIG. 1(a), there is a number N of vehicles driving in a convoy on the second lane, including a second vehicle and a third vehicle. The N vehicles, for example, can be driving automatically and with a minimized separation in order to minimize energy consumption.

The starting point is now a lane change request of a first vehicle from the first lane A to the third lane C, which is communicated to the vehicles in the vicinity of the first vehicle 10, for example via V2X communication.

Based on the lane change request of the first vehicle 10, cooperative driving maneuvers of the vehicles on the second lane B are determined that enable the first vehicle 10, for example to change from the first lane A to the second lane B and then the third lane C without braking. The driving maneuvers are determined in such a way that a number of participating vehicles is minimal (for example, two vehicles per lane with a convoy). As a result, it can be prevented that more vehicles than the minimum number have to brake and/or accelerate, so that energy consumption can be minimized.

Referring to FIG. 1(b), the second vehicle performs a lane change from the second lane B to the first lane A. For example, the second vehicle 20 can change to the first lane A in front of the first vehicle 10.

Referring to FIG. 1(c), the third vehicle performs an acceleration process to create a gap in the second lane B level with the first vehicle 10, which is still in the first lane A. For example, the third vehicle 30 can perform the acceleration process in such a way that the third vehicle 30 occupies a place of the second vehicle 20 in the second lane B that has become vacant due to a lane change that has taken place previously. In some embodiments, the third vehicle 30 may be level with the second vehicle 20 or next to the second vehicle 20 after the acceleration process.

Referring to FIG. 1(d), the first vehicle 10 performs a first lane change into the gap in the second lane B and a second lane change to the third lane C.

Referring to FIG. 1(e1), the third vehicle 30 performs a deceleration process in order to vacate the original place of the second vehicle 20 in the second lane B and to return to its own place in the convoy in the second lane B.

Referring to FIG. 1(f1), the second vehicle 20 performs a lane change from the first lane A to the second lane B back to its original place after the deceleration process of the third vehicle 30. In particular, the second vehicle can perform the lane change from the first lane A to the second lane B in front of the third vehicle. As a result, the original configuration of the convoy in the second lane B is restored with minimal driving maneuvers.

As an alternative to FIG. 1(e1) and 1(f1), the second vehicle 20 can perform a deceleration process (FIG. 1(e2)) before the lane change to the second lane B in order to cut back into the second lane B behind the third vehicle 30 (FIG. 1(f2)) with a subsequent lane change. Compared to the initial situation, the second vehicle 20 and the third vehicle 30 have therefore changed places in the convoy.

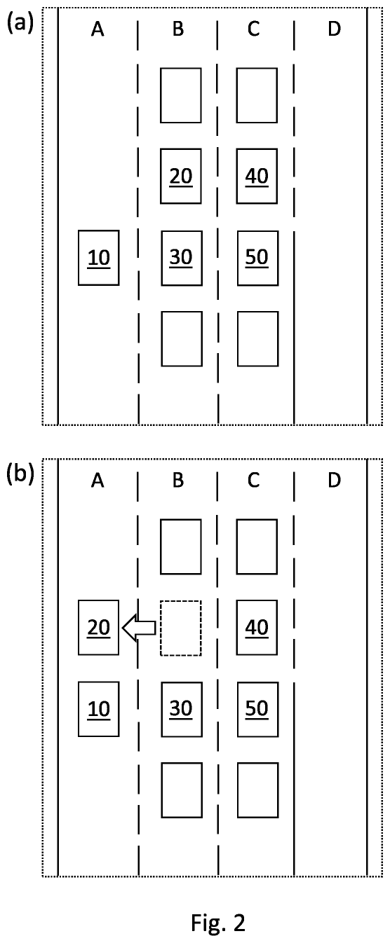

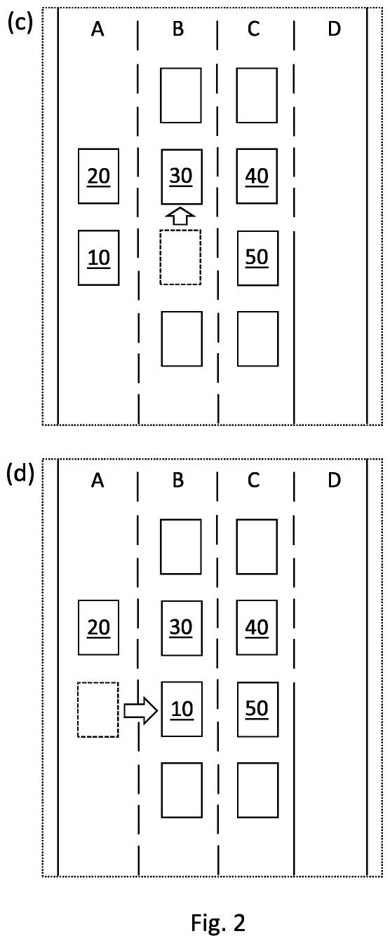

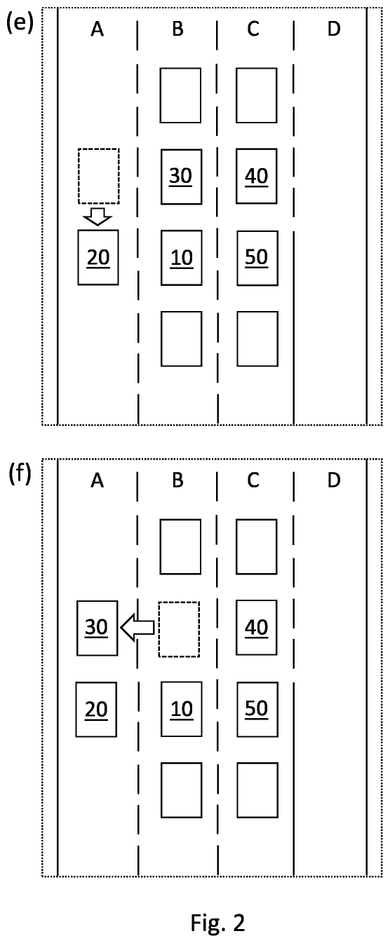

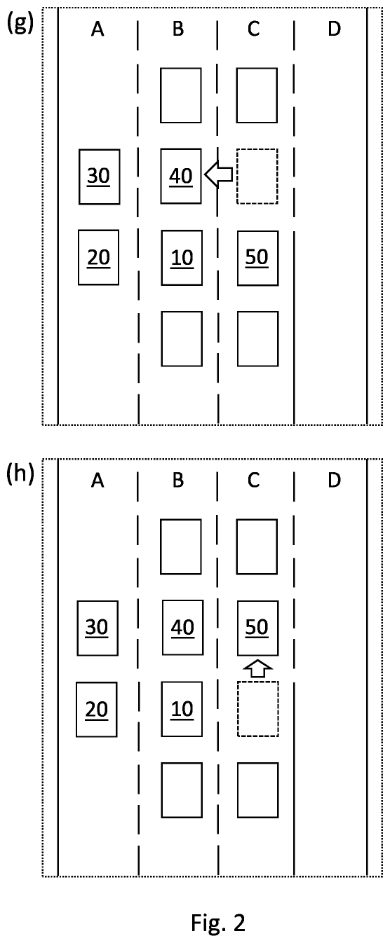

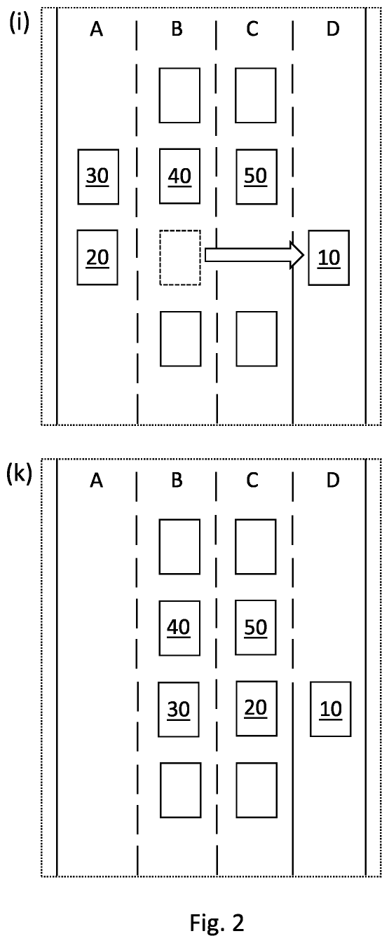

FIG. 2 depicts schematically cooperative driving maneuvers according to further embodiments of the present disclosure.

A first lane A, a second lane B, a third lane C and a fourth lane D, which are arranged next to each other in that order, are depicted schematically. The fourth lane D can be a deceleration lane or an exit (for example a freeway exit) in some embodiments but is not limited to this.

Referring to FIG. 2(a), there is a number N of vehicles travelling in a convoy in the second lane B, including a second vehicle 20 and a third vehicle 30. The N vehicles, for example, can be driving automatically and with minimized separation in order to minimize energy consumption. In addition, there are a number M of vehicles in the third lane C, which are driving in a convoy, comprising a fourth vehicle 40 and a fifth vehicle 50. The M vehicles, for example, can be driving automatically and with minimized separation in order to minimize energy consumption.

The starting point is now a lane change request of a first vehicle 10 from the first lane A to the fourth lane D, which is communicated to the vehicles in the vicinity of the first vehicle 10, for example via V2X communication.

Based on the lane change request of the first vehicle 10, cooperative driving maneuvers are determined of the vehicles on the second lane B and the third lane C, which enable the first vehicle 10, for example, to perform change changes sequentially from the first lane A to the second lane B, from the second lane B to the third lane C, and from the third lane C to the fourth lane D without braking. The driving maneuvers are determined in such a way that a number of participating vehicles is minimal (for example, two vehicles per lane with convoy driving). In this way it can be prevented that more vehicles than the minimum number have to brake and/or accelerate, so that energy consumption can be minimized.

Referring to FIG. 2(b), the second vehicle 20 performs a lane change from the second lane B to the first lane A. For example, the second vehicle 20 can change to the first lane A in front of the first vehicle 10.

Referring to FIG. 2(c), the third vehicle 30 performs an acceleration process to create a gap in the second lane B level with the first vehicle 10, which is still in the first lane A. For example, the third vehicle 30 can perform the acceleration process in such a way that the third vehicle 30 occupies a place of the second vehicle 20 on the second lane B, which has become vacant due to its previously completed lane change. In some embodiments, after the acceleration process the third vehicle 30 may be located level with the second vehicle 20 or next to the second vehicle 20.

Referring to FIG. 2(d), the first vehicle 10 performs a first lane change into the gap in the second lane B. For example, the first vehicle 10 may be behind the third vehicle 30 after the first lane change.

Referring to FIG. 2(e), the second vehicle 20 performs a deceleration process in the first lane A, so that the second vehicle 20 is in the first lane A level with the first vehicle 10 in the second lane B. For example, the second vehicle 20 can perform the deceleration process in such a way that the second vehicle 20 occupies a place of the first vehicle 10 in the first lane A that has been vacated by its previously performed first lane change to the second lane B.

Referring to FIG. 2(f), the third vehicle 30 performs a lane change from the second lane B to the first lane A. For example, the third vehicle 30 can change to the first lane A in front of the second vehicle 20.

Referring to FIG. 2(g), the fourth vehicle 40 performs a lane change from the third lane C to the second lane B, for example so that the fourth vehicle 40 is in the second lane B next to the third vehicle 30 in the first lane A and/or in front of the first vehicle 10. For example, the fourth vehicle 40 can change lanes in such a way that the fourth vehicle 40 occupies a place of the third vehicle 30 in the second lane B that has become vacant due to its previously performed lane change to the first lane A.

Referring to FIG. 2(h), the fifth vehicle 50 performs an acceleration in the third lane C in order to create another gap in the third lane C, in particular level with the first vehicle 10 in the second lane B. The fifth vehicle 50 can perform the acceleration process for example in such a way that the fifth vehicle 50 is in the third lane C level with the fourth vehicle 40 in the second lane B. In some embodiments, the fifth vehicle 50 can perform the acceleration process in such a way that the fifth vehicle 50 occupies a place of the fourth vehicle 40 in the third lane C that has been vacated by its previously performed lane change to the second lane B.

Referring to FIG. 2(i), the first vehicle 10 can perform a second lane change into the further gap in the third lane C. For example, the first vehicle 10 may be behind the fifth vehicle 50 after the second lane change. Subsequently, the first vehicle 10 can perform a third lane change from the third lane C to the fourth lane D.

Referring to FIG. 2(k), further driving maneuvers can be performed to restore the convoy. In particular, the second vehicle 20 and the third vehicle 30 can move from the first lane A back to the convoy lanes B and/or C. Such further driving maneuvers are explained below by way of example.

In some embodiments, the second vehicle 20 performs the lane change from the first lane A back to the second lane B. For example, the second vehicle 20 can perform the lane change behind the fourth vehicle 40. Subsequently, the second vehicle can make another lane change from the second lane B to the third lane C, for example behind the fifth vehicle 50.

The third vehicle 30 may perform a deceleration process in the first lane A. For example, the third vehicle 30 may perform the deceleration process in such a way that the third vehicle 30 occupies a place of the second vehicle 20 in the first lane A that has been vacated by its previously performed lane change to the second lane B.

The third vehicle 30 may then perform a lane change from the first lane A to the second lane B. For example, the third vehicle 30 can perform the lane change behind the fourth vehicle 40 in the second lane B.

In some implementations, the first vehicle 10 of FIGS. 1 and 2 is a motor vehicle for the transport of passengers.

In addition or alternatively, the second vehicle 20 and/or the third vehicle 30 and/or the fourth vehicle 40 and/or the fifth vehicle 50 of FIGS. 1 and 2 are trucks. In particular, the second vehicle 20, the third vehicle 30, the fourth vehicle 40 and the fifth vehicle 50 can be convoy vehicles that are driving automatically in a convoy.

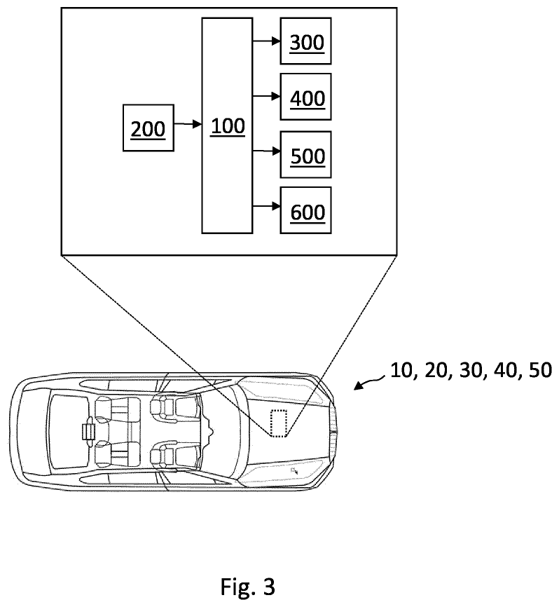

FIG. 3 schematically shows a vehicle 10, 20, 30, 40, 50 with a driver assistance system 100 for automated driving according to embodiments of the present disclosure.

In the case of automated driving in accordance with the embodiments of the present disclosure, the lateral guidance (and optionally the longitudinal guidance) of the vehicle 10, 20, 30, 40, 50 is automatic. The driver assistance system 100 therefore undertakes the vehicle guidance. For this purpose, the driver assistance system 100 controls the steering 300 and, optionally, the drive 400, the gearbox 500 and the service brake 600 via intermediate units that are not shown.

For the planning and performance of the automated driving, environmental information from an environment sensor system that observes the surroundings of the vehicle is received by the driver assistance system 100. In particular, the vehicle may contain at least one environment sensor 200 capable of recording environmental data indicating the environment of the vehicle. For example, the at least one environment sensor 200 can contain one or more LiDAR systems, one or more radar systems, one or more ultrasonic sensors, and/or one or more cameras.

In some implementations, the second vehicle 20, the third vehicle 30, the fourth vehicle 40 and the fifth vehicle 50 as well as optionally the first vehicle 10 are automatically driving vehicles. In other words, the second vehicle 20, the third vehicle 30, the fourth vehicle 40 and the fifth vehicle 50 as well as optionally the first vehicle 10 can each be equipped with a driver assistance system for automated driving.

For example, the driver assistance system 100 of the first vehicle 10 of the present disclosure may contain a lane change assistant. For example, the lane change assistant may contain an actuating element for a directional indicator, wherein the actuating element may be set up to initiate an automated lane change according to the lane change planning according to the invention when activated or triggered by a driver when the lane change assistant is active. The actuating element can have a turn signal lever and a multiple function, namely the activation of the turn indicator and triggering of the automatic lateral guidance process.

However, the embodiments of the present disclosure are not limited to automated driving. In alternative embodiments, using at least one output device the driver assistance system 100 of the first vehicle 10 can output driver information with reference to the lane change planning carried out when the vehicle is driven manually. The driver information may in particular give the driver information about lane changes.

Although the invention has been illustrated and explained in detail by preferred exemplary embodiments, the invention is not limited by the disclosed examples and other variations can be deduced from this by the person skilled in the art without departing from the scope of protection of the invention. It is therefore clear that a number of variation possibilities exists. It is also clear that the embodiments mentioned by way of example are really only examples that are not to be understood in any way as limiting the scope of protection, the possible applications, or the configuration of the invention. Rather, the description above and the description of figures enable the person skilled in the art to implement the exemplary embodiments in concrete terms, wherein the person skilled in the art, knowing the disclosed idea of the invention, can make a variety of changes, for example with regard to the function or arrangement of individual elements mentioned in an exemplary embodiment, without departing from the scope of protection, which is defined by the claims and their legal equivalents, such as further explanations in the description.

1-14. (canceled)

15. A driver assistance method for vehicles, comprising:
performing cooperative driving maneuvers by a plurality of vehicles to allow a first vehicle of the plurality of vehicles to perform a first lane change from a first lane to a second lane and then a second lane change from the second lane to a third lane, wherein the second lane is located between the first lane and the third lane, wherein the performance of cooperative driving maneuvers by the plurality of vehicles includes:
performing driving maneuvers by two vehicles of the plurality of vehicles that are located one behind the other in the second lane to create a gap in the second lane, wherein a second vehicle of the two vehicles performs a lane change, and a third vehicle of the two vehicles performs a deceleration or acceleration process in order to create the gap in the second lane; and
sequential performance, by the first vehicle, of the first lane change into the gap in the second lane and the second lane change to the third lane.

16. The driver assistance method according to claim 15, wherein at least one of:
the second vehicle performs the lane change from the second lane to the first lane, in particular in front of the first vehicle in the first lane;
the third vehicle performs the deceleration or acceleration process in order to create the gap level with the first vehicle; or
the second vehicle performs a lane change from the first lane back to the second lane after the first vehicle has performed the second lane change to the third lane, wherein the second vehicle performs the lane change in front of or behind the third vehicle.

17. The driver assistance method according to claim 15, wherein the third lane is selected from the group consisting of a breakdown lane, a deceleration lane, and an exit.

18. The driver assistance method according to claim 15, wherein the performance of the cooperative driving maneuvers by the plurality of vehicles comprises:
performing cooperative driving maneuvers by two other vehicles of the plurality of vehicles located one behind the other in the third lane in order to create another gap in the third lane, wherein a fourth vehicle of the two other vehicles performs a lane change and a fifth vehicle of the two other vehicles performs a deceleration or acceleration process in order to create the further gap in the third lane, wherein the first vehicle sequentially performs the first lane change into the gap in the second lane, the second lane change into the further gap in the third lane and a third lane change into the fourth lane.

19. The driver assistance method according to claim 18, wherein:
the second vehicle performs the lane change from the second lane to the first lane, in particular in front of the first vehicle in the first lane;
the third vehicle performs a lane change from the second lane to the first lane; and
the fourth vehicle performs a lane change from the third lane to the second lane.

20. The driver assistance method according to claim 18, wherein at least one of:
the second vehicle performs a lane change from the first lane back to the second lane and optionally a further lane change from the second lane to the third lane after the first vehicle has performed the second lane change to the third lane and optionally the third lane change to the fourth lane;
the third vehicle performs a deceleration or acceleration process in the first lane; or
the third vehicle performs a lane change from the first lane back into the second lane.

21. The driver assistance method according to claim 18, wherein the fourth lane (D) is selected from the group consisting of a breakdown lane, a deceleration lane, and an exit.

22. The driver assistance method according to claim 15, wherein the plurality of vehicles communicate with each other by means of vehicle-to-vehicle, V2V, communication and/or vehicle-to-X, V2X, communication and/or a mobile network in order to perform the driving maneuvers cooperatively.

23. The driver assistance method according to claim 15, wherein at least one of:
the vehicle of the plurality of vehicles are automatically driving vehicles;
the first vehicle is a motor vehicle; or
at least one of the second vehicle, the third vehicle, the fourth vehicle, or the fifth vehicle is a truck.

24. A system for performing cooperative driving maneuvers by a plurality of vehicles, comprising:
processors; and
memories connected to the processors and storing instructions that when executed by the processors, cause the processors to perform the driver assistance method according to claim 15.

25. A method for determining cooperative driving maneuvers, comprising:
determining driving maneuvers for a plurality of vehicles in order to allow a first vehicle of the plurality of vehicles to perform a first lane change from a first lane to a second lane and a subsequent second lane change from the second lane to a third lane, wherein the second lane is located between the first lane and the third lane, wherein the determination of cooperative maneuvers for the plurality of vehicles includes:
determining driving maneuvers for two vehicles of the plurality of vehicles that are located one behind the other in the second lane to create a gap in the second lane, wherein the driving maneuvers for a second vehicle of the two vehicles include a lane change and for a third vehicle of the two vehicles include a deceleration or acceleration process in order to create the gap in the second lane so that the first vehicle can sequentially perform the first lane change into the gap in the second lane and the second lane change to the third lane.

26. The method according to claim 25, wherein the method is carried out by one or more processors of the second vehicle or the third vehicle.

27. A computer-readable storage medium, storing instructions that when executed by one or more processors cause the one or more processors to carry out the method according to claim 25.

28. A system for determining cooperative driving maneuvers, comprising:
one or more processors; and
at least one memory that is connected to the one or more processors storing instructions that when executed by the one or more processors, cause the one or more processors to determine cooperative driving maneuvers for a plurality of vehicles in order to enable a first vehicle of the plurality of vehicles to perform a first lane change from a first lane to a second lane and then a second lane change from the second lane to a third lane, wherein the second lane is located between the first lane and the third lane, wherein the determination of cooperative driving maneuvers for the plurality of vehicles comprises:
determining driving maneuvers for two vehicles of the plurality of vehicles that are located one behind the other in the second lane to create a gap in the second lane, wherein the driving maneuvers for a second vehicle of the two vehicles include a lane change and for a third vehicle of the two vehicles include a deceleration or acceleration process in order to create the gap in the second lane so that the first vehicle can sequentially perform the first lane change into the gap in the second lane and the second lane change to the third lane.
